(19) United States
(12) Patent Application Publication
(10) Pub. No.: US 2020/0090212 A1
(43) Pub. Date: Mar. 19, 2020

(54) SYSTEMS AND METHODS FOR EVALUATING EFFECTIVENESS OF OUTDOOR OR INDOOR ADVERTISEMENTS

(71) Applicant: STICKERRIDE LTD, London (GB)

(72) Inventor: Mikhail MARCHENKO, Moscow (RU)

(21) Appl. No.: 16/693,857

(22) Filed: Nov. 25, 2019

Related U.S. Application Data
(63) Continuation-in-part of application No. 15/216,637, filed on Jul. 21, 2016.

(51) Int. Cl. G06Q 30/02; G06Q 50/00

(52) U.S. Cl. CPC G06Q 30/0246; G06Q 30/0273; G06Q 50/01

(57) ABSTRACT

Assessment of the effectiveness of outdoor or indoor advertising includes the analysis of user interaction data with outdoor or indoor advertising. This analysis is carried out using a mobile application that allows users in the form of a game or quest to detect various items that are the subject of an advertising campaign, take photos or videos and quickly repost them in their personal social media account. The described system generates the following results: a comparative analysis of advertising objects used in an advertising campaign; the effectiveness of this campaign as a whole compared to another campaign; the effectiveness of this advertising object in a particular campaign compared to using the same object in another campaign; comparative analysis of various objects of creative content used in one advertising campaign; as well as any other custom analytics requested by the advertiser.

### CROSS REFERENCE TO RELATED APPLICATIONS

The present patent application is a Continuation-in-part of the US patent application U.S. Ser. No. 15/216,637 filed on Jul. 21, 2016.

### FIELD OF INVENTION

The disclosed embodiments relate in general to advertising techniques, more specifically, to systems and methods for evaluating effectiveness of outdoor or indoor advertisements.

### BACKGROUND

In addition to the classical outdoor advertising, which includes billboards with static content and electronic displays displaying dynamic advertising content, transit outdoor advertising, e.g. the advertising content placed on cars, trucks and other road or other surface or air vehicles, such as boats or aircraft, is becoming more end more popular, especially in large metropolitan areas such as New York City, Los Angeles as well as others. Such advertising content may be static, when the content displayed on the vehicle does not change, as in case of permanently affixed stickers or decals, or dynamic, when the vehicle is equipped with an electronic billboard displaying dynamic advertising content, such as video advertisements. In addition, an associated audio content may be provided.

As would be appreciated by persons of skill in the art, effectiveness of outdoor or indoor advertisements is a big and important question for any brand or media agency. A classical approach to evaluating the effectiveness of advertisements involves estimating a number of impressions generated by advertisement using statistical data (e.g. historical data on human and transport traffic in specific places, etc.) or technical equipment (e.g. cameras counting people, iBeacon/Bluetooth counting devices, etc). However, it is much more important for the advertiser to measure and evaluate the effect, which the advertisement had on real individuals and to be able to compare the respective advertisement effects corresponding to different locations and formats.

As would be appreciated by persons of ordinary skill in the art, in view of the above and other deficiencies of the conventional approach to evaluating effectiveness of outdoor or indoor advertisements, a new and improved advertisement evaluation approach would be highly desirable.

### SUMMARY OF THE INVENTION

The embodiments described herein are directed to methods and systems that substantially obviate one or more of the above and other problems associated with conventional approach for evaluating the effectiveness of advertisements.

In accordance with one aspect of the inventive concepts described herein, there is provided a computer-implemented method for calculating user incentives in connection with outdoor or indoor advertisement(s), the method being performed in connection with a computerized system comprising a central processing unit, a positioning device, a display device and a memory, the computer-implemented method comprising: using the central processing unit to post a photo or a video taken by a user in a social network; checking whether the posted photo or video is still available in the social network; if the posted photo or video is still available, determining a level of other user interaction with the posted photo or video; specifying a rate information applicable to an advertising campaign corresponding to the posted photo or video and the social network; and calculating a number of points (P) earned by the user for the posted photo or video in the social network based on determined rate information and the determined level of interaction.

In one or more embodiments, the level of other user interaction with the posted photo or video is determined based on a number (L) of “likes” collected by the posted photo or video in the social network.

In one or more embodiments, the level of other user interaction with the posted photo or video is determined based on a number of reposts (S) collected by the posted photo or video in the social network.

In one or more embodiments, the level of other user interaction with the posted photo or video is determined based on a number of views (V) of the posted photo or video in the social network.

In one or more embodiments, the rate information comprises a price per friend/follower (pF), price per like (pL) and price per repost (pS), limit for friend/follower (limF), limit for likes (limL) and limit for reposts (limS), price per watched video (pV) and limit for number of times video can be watched (limV).

In one or more embodiments, the method further comprises determining a number (F) of friends and followers of a profile of the user in the social network, wherein the number of points (P) earned by the user for the posted photo in the social network is calculated according to a formula: P=if(F>lim F; LOG(F; 2)*pF*lim F/LOG(lim F; 2); pF*F)+if(L>lim L; LOG(L; 2)*pL*lim L/LOG(lim L; 2); pL*L)+if(S>lim S; LOG(S; 2)*pS*lim S/LOG(lim S; 2); pS*S) or any other function that is linear to number of friends, number of likes, number of reposts and switches to logarithmic after a certain limit. For posted video formula is going to be P=if(V>limV; LOG(V; 2)*pV*lim V/LOG(lim V; 2); pV*V)+if(L>lim L; LOG(L; 2)*pL*lim L/LOG(lim L; 2); pL*L)+if(S>lim S; LOG(S; 2)*pS*lim S/LOG(limS; 2); pS*S) or any other function that is linear to number of times video was watched, number of likes, number of reposts and switches to logarithmic after a certain limit.

In one or more embodiments, checking whether the posted photo or video is still available in the social network during a predetermine period of time comprises determining whether the posted photo or video exists and can be accessed without any restriction by any user.

In one or more embodiments, if the posted photo or video is not available to everybody, it is treated as “unavailable”.

In accordance with another aspect of the inventive concepts described herein, there is provided a computer-implemented method for evaluating effectiveness of outdoor or indoor advertisement(s), the method being performed in connection with a computerized system comprising a central processing unit, a positioning device, a display device and a memory, the computer-implemented method comprising: receiving data on a plurality of postings made for a predetermined advertising campaign, associating each posting of the plurality of postings with an advertisement object of a plurality of advertisement objects; and determining the effectiveness of outdoor or indoor advertisement(s) based on statistical analysis of a number of associated postings.

In one or more embodiments, the method further comprises computing, for each of the plurality of postings, an engagement rate.

In one or more embodiments, each posting of the plurality of postings is associated with the advertisement object of the plurality of advertisement objects by means of an algorithm for building Voronoi diagram.

In one or more embodiments, the method further comprises comprising using statistical distribution of advertisement objects comprising groups of best and worst performing objects in the predetermined advertising campaign, average performance of advertising objects in the predetermined advertising campaign compared to average for other campaigns in a database, comparison of performance of the advertising object among several advertising campaigns and other analytics.

In one or more embodiments, the method further comprises using standard computational instruments to determine statistical distribution of creatives, comprising groups of best and worst performing creatives in the predetermined advertising campaign, average performance of creative in the predetermined advertising campaign compared to average for other campaigns in a database, comparison of performance of creatives located at the advertising object among several advertising campaigns (can be helpful to determine social demography and profile of audience around this advertising object) and other analytics.

In one or more embodiments, the engagement rate comprises a first engagement rate computed based on a number of likes of the posting.

In one or more embodiments, the method further comprises determining a number (F) of friends and followers of a profile of the user in the social network, wherein the first engagement rate is computed by dividing the number of likes of the posting by a number of friends and followers of a corresponding user who made the posting.

In one or more embodiments, the engagement rate comprises a second engagement rate calculated based on a number of reposts of the posting.

In one or more embodiments, the method further comprises determining a number (F) of friends and followers of a profile of the user in the social network, wherein the second engagement rate is computed by dividing the number of reposts of the posting by a number of friends and followers of a corresponding user who made the posting.

In one or more embodiments, the engagement rate comprises a third engagement rate calculated based on a number of views of the posting.

In one or more embodiments, the method further comprises determining a number (F) of friends and followers of a profile of the user in the social network, wherein the third engagement rate is computed by dividing the number of views of the posting by a number of friends and followers of a corresponding user who made the posting.

In accordance with yet another aspect of the inventive concepts described herein, there is provided a non-transitory computer-readable medium embodying a set of computer-executable instructions, which, when executed in a computerized system comprising a central processing unit, a positioning device, a display device and a memory, cause the computerized system to perform a computer-implemented method for calculating user incentives in connection with outdoor or indoor advertisement(s), the method comprising: using the central processing unit to post a photo or a video taken by a user in a social network; checking whether the posted photo or video is still available in the social network; if the posted photo or video is still available, determining a level of other user interaction with the posted photo or video; specifying a rate information applicable to an advertising campaign corresponding to the posted photo or video and the social network; and calculating a number of points (P) earned by the user for the posted photo or video in the social network based on determined rate information and the determined level of interaction.

In one or more embodiments, the level of other user interaction with the posted photo or video is determined based on a number (L) of “likes” collected by the posted photo or video in the social network.

In one or more embodiments, the level of other user interaction with the posted photo or video is determined based on a number of reposts (S) collected by the posted photo or video in the social network.

In one or more embodiments, the level of other user interaction with the posted photo or video is determined based on a number of views (V) of the posted photo or video in the social network.

In one or more embodiments, the rate information comprises a price per friend/follower (pF), price per like (pL) and price per repost (pS), limit for friend/follower (limF), limit for likes (limL) and limit for reposts (limS), price per watched video (pV) and limit for number of times video can be watched (limV).

In one or more embodiments, the method further comprises determining a number (F) of friends and followers of a profile of the user in the social network, wherein the number of points (P) earned by the user for the posted photo in the social network is calculated according to a formula: P=if(F>lim F; LOG(F; 2)*pF*lim F/LOG(lim F; 2); pF*F)+if(L>lim L; LOG(L; 2)*pL*lim L/LOG(lim L; 2); pL*L)+if(S>lim S; LOG(S; 2)*pS*lim S/LOG(lim S; 2); pS*S) or any other function that is linear to number of friends, number of likes, number of reposts and switches to logarithmic after a certain limit. For posted video formula is going to be: P=if(V>limV; LOG(V; 2)*pV*lim V/LOG(lim V; 2); pV*V)+if(L>lim L; LOG(L; 2)*pL*lim L/LOG(lim L; 2); pL*L)+if(S>lim S; LOG(S; 2)*pS*lim S/LOG(lim S; 2); pS*S) or any other function that is linear to number of times video was watched, number of likes, number of reposts and switches to logarithmic after a certain limit.

In one or more embodiments, checking whether the posted photo or video is still available in the social network during a predetermine period of time comprises determining whether the posted photo or video exists and can be accessed without any restriction by any user.

In one or more embodiments, if the posted photo or video is not available to everybody, it is treated as “unavailable”.

In accordance with yet another aspect of the inventive concepts described herein, there is a power independent, computer-readable medium embodying a set of computer-executable instructions, which, when executed in a computerized system comprising a central processing unit, a positioning device, a display device and a memory, cause the computerized system to perform a computer-implemented method for evaluating effectiveness of outdoor or indoor advertisement(s), the method comprising: receiving data on a plurality of postings made for a predetermined advertising campaign; associating each posting of the plurality of postings with an advertisement object of a plurality of advertisement objects; and determining the effectiveness of outdoor or indoor advertisement(s) based on statistical analysis of a number of associated postings.

In one or more embodiments, the method further comprises computing, for each of the plurality of postings, an engagement rate.

In one or more embodiments, each posting of the plurality of postings is associated with the advertisement object of the plurality of advertisement objects by means of an algorithm for building Voronoi diagram.

In one or more embodiments, the method further comprises comprising using statistical distribution of advertisement objects comprising groups of best and worst performing objects in the predetermined advertising campaign, average performance of advertising objects in the predetermined advertising campaign compared to average for other campaigns in a database, comparison of performance of the advertising object among several advertising campaigns and other analytics.

In one or more embodiments, the method further comprises using standard computational instruments to determine statistical distribution of creatives, comprising groups of best and worst performing creatives in the predetermined advertising campaign, average performance of creative in the predetermined advertising campaign compared to average for other campaigns in a database, comparison of performance of creatives located at the advertising object among several advertising campaigns (can be helpful to determine social demography and profile of audience around this advertising object) and other analytics.

In one or more embodiments, the engagement rate comprises a first engagement rate computed based on a number of likes of the posting.

In one or more embodiments, the method further comprises determining a number (F) of friends and followers of a profile of the user in the social network, wherein the first engagement rate is computed by dividing the number of likes of the posting by a number of friends and followers of a corresponding user who made the posting.

In one or more embodiments, the engagement rate comprises a second engagement rate calculated based on a number of reposts of the posting.

In one or more embodiments, the method further comprises determining a number (F) of friends and followers of a profile of the user in the social network, wherein the second engagement rate is computed by dividing the number of reposts of the posting by a number of friends and followers of a corresponding user who made the posting.

In one or more embodiments, the engagement rate comprises a third engagement rate calculated based on a number of views of the posting.

In one or more embodiments, the method further comprises determining a number (F) of friends and followers of a profile of the user in the social network, wherein the third engagement rate is computed by dividing the number of views of the posting by a number of friends and followers of a corresponding user who made the posting.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

The described technical solution allows you to process large amounts of information/data/publications, which is inaccessible to humans. For example, the processing speed of 100,000 publications will take no more than 10 minutes for the claimed solution (depending on the hardware and software used), and for a person it will take no less than 1,660 man-hours, which will not allow efficiently calculating the user rewards (points) taking into account constant every minute change/deletion/adding publications by various users.

In some embodiments, the described technical solution may have a pool of accounts on the social network that are automatically added as friends to those user accounts that are closed to the public. In some implementations, when automatically added, the user is sent a message stating that this account is necessary to track interaction and calculate rewards.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive concepts. Specifically:

FIG. 1 illustrates a logical diagram of one exemplary embodiment of an inventive computerized system for evaluating effectiveness of outdoor or indoor advertisement(s).

FIG. 2 illustrates exemplary internal data and command flows between various components of the inventive computerized system for evaluating effectiveness of outdoor or indoor advertisement(s) shown in FIG. 1.

FIG. 3 illustrates an exemplary block diagram of an embodiment of a software algorithm for calculating user incentives in connection with outdoor or indoor advertisement(s) performed in conjunction with the computerized system shown in FIG. 1.

FIG. 4A illustrates an exemplary embodiment of an algorithm for processing of analytical data to compute effectiveness of advertising inventory used outdoor/indoor campaign.

FIG. 4B illustrates an exemplary embodiment of an algorithm for processing of analytical data to compute effectiveness of creative used in outdoor/indoor advertising campaign.

FIGS. 5A, 5B, 5C illustrate exemplary embodiments of a user interface of the aforesaid computerized system for evaluating effectiveness of outdoor or indoor advertisement(s) shown in FIG. 1.

FIG. 6 illustrates an exemplary embodiment of a computerized mobile system that could be used as the user's mobile device 2 in connection with the computerized system for evaluating effectiveness of outdoor or indoor advertisement(s) shown in FIG. 1.

FIG. 7 illustrates an exemplary embodiment of a computerized server system 3, which could be used, for example, as the server of the inventive computerized system for evaluating effectiveness of outdoor or indoor advertisement(s).

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

To address the above and other problems associated with the conventional technology, one or more embodiments described herein implement various exemplary computerized systems and computer-implemented methods for evaluating effectiveness of outdoor or indoor advertisement(s).

In the present description of the invention, the terms “module”, “component”, “element” and the like are used to refer to computer entities, which may be hardware/equipment (e.g., device, instrument, apparatus, apparatus, component of the device, for example, processor, microprocessor, integrated circuit, printed circuit board, including electronic printed circuit board, breadboard, motherboard, etc., microcomputer and so on), software (for example, use executable program code, a compiled application, program module, a piece of software or program code, and so on) and/or firmware (in particular, firmware). So, for example, a component can be a process running on a processor (s), an object, executable code, program code, a file, a program (application), a function, a method, a (software) library, a subprogram, a coroutine, and/or a computing device (for example, microcomputer or computer) or a combination of software or hardware components. So, in the particular case, the application running on the server can be a component (module), and the server, in turn, can be a component (module). It is worth noting that at least one component (module) can be part of the process. A component (module) can be located on one computing device (for example, a microcomputer, microprocessor, printed circuit board, etc.) and/or can be distributed (shared) between several computing devices.

In one or more embodiments, evaluating effectiveness of outdoor or indoor advertisements involves analysis of data on human user interaction with outdoor or indoor advertisements. In one exemplary embodiment, this analysis is accomplished using a mobile application executing on a mobile computing device such as a smartphone or a tablet, which enables users to locate various items that are the objects in an advertising campaign, take pictures or videos and easily repost them in a personal account in social media in the form of the game or a quest on the server side, computerized systems/computer systems and computer-implemented (computer-based) methods are provided that automatically calculate (count) and rank (classify) quality compliance and engagement for a set of advertising objects, as well as a creative approach (in particular, creatives) used in internal and external advertising campaigns (in a particular case, an analysis is carried out of the level of involvement that the advertising object generates, as described in scope of this technical solution) using an analysis of user generated (generated) content published on social media.

In one or more embodiments, an implementation of the described computerized system generates one or more of the following results: 1) comparative analysis of advertising objects used in an advertising campaign; 2) effectiveness of given campaign as a whole compared to another campaign; 3) effectiveness of a given advertising object in a specific campaign compared to the use of the same object in another campaign; 4) comparative analysis of different items of creative content used in the same advertising campaign; and 5) any and all other custom analytics as requested by the advertiser.

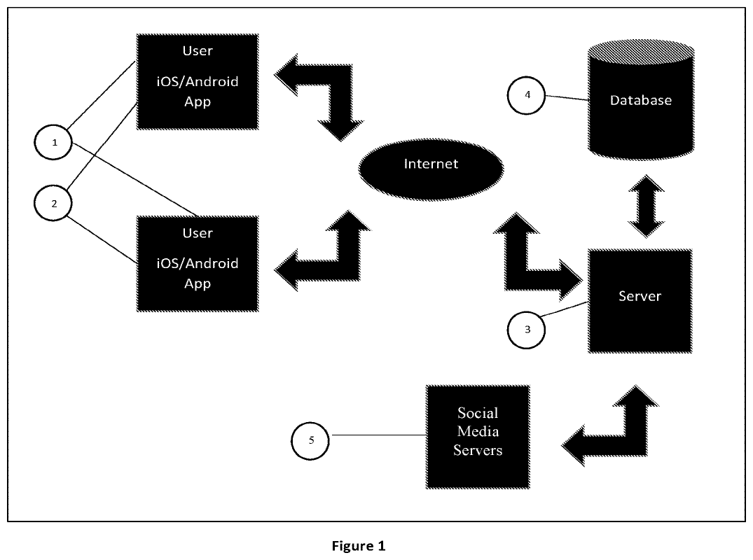

FIG. 1 illustrates a logical diagram of one exemplary embodiment of an inventive computerized system for evaluating effectiveness of outdoor or indoor advertisement(s). In one or more embodiments, in FIG. 1, an element 1 designates a human user with a smartphone who has been previously registered with the computerized system and who has at list one social media account (e.g. Facebook, Instagram, etc. account) linked to his or her profile in the aforesaid computerized system. So, for example, a user profile can be created by the user in application 2. The created user profile can be connected (including by the user) in the described social networks (social media), in particular by connecting the user in social networks to user information in the user application 213, and the user can authorize the application 213 to carry out the described actions (for example, to publish content (posts), view the number of likes and reposts (republishing) for such posts (content, etc.) within the scope of the technical solutions in the user's social network.

In one or more embodiments, an element 2 in FIG. 1 designates each user's 1 smartphone with an iOS or Android mobile application (not shown), the functionality of which will be described in detail below. When the user 1 makes a photo or video using this mobile application, such mobile application transfers the received (resulting) photos or videos to server 3 (by standard means for each specific social network by using the API of such a social network or by the user), i.e. in the particular case, the publication of content (photo or video) on behalf of the user is carried out, and the transfer of content (photo and/or video) can be carried out together with the user's location, for example, GPS position, or other information about the location of at least one user 1 and the list of social media networks (social networks), which is stored in the user information and in which application 213 is authorized to publish content on behalf of the user, and in which User may publish (post) of such content. It is worth noting that data on the location of the user (in particular, the computing device of the user, for example, a smartphone) can be obtained by a user application that is allowed access to the module for registering the location of the user, in particular, to the GPS module of the user device (e.g., smartphone).

In the particular case of the implementation of this technical solution, the content is transferred (photos, videos, etc.) to the server 3 without being stored in the smartphone data storage (user device). For example, a mobile application may limit the ability of a user to save photos, videos, etc. (in the particular case, the creation of which is carried out using the described application) in the data storage of the user's device (smartphone). It is also worth noting that when publishing content, including photos, videos, etc., the user may be limited or prevented from publishing content on social media stored in the user's device's storage, and the prohibition on publishing is carried out by means of application 213, in particular, the user is blocked from access to the gallery (publications), in which photos and videos made by the user are stored using application 213. In the particular case of the current technical solution such blocking can be accomplished by user application means.

It is worth noting that user publications can be carried out (in a particular case, added, including through a personal account, described application, etc. and/or by means of other modules of the described system) in social networks (social media). It is worth noting that for adding content APIs of various services (in particular, social networks) can be used, in particular, allowing you to add photos, share data (in private, via content sharing), etc. It is also worth noting that management, addition, publication, transfer, etc. of the content and/or data can be carried out through user devices (in particular, smartphones), for example, through the described application installed on the user devices, through the use of web interfaces, various messaging services, or by sending at least one message containing data for management, publishing, etc.

In one embodiment of the technical solution, element 3 of FIG. 1 is a server that is a part of the computer system described in this technical solution for evaluating the effectiveness of outdoor or indoor advertising. Server 3 is (communicatively) connected to a data transfer network (data network), such as, for example, the Internet, and is configured to receive data from all users, to automatically publish predefined content to various social media networks, to track (monitor) the availability of publications (posts) in the above social media/social media networks (social networks), in particular tracking the fact that publications have not been deleted, and to perform any and all necessary calculations (in particular, to calculate the number of likes and reposts) for providing analytics (for example, the number of publications by day in terms of social networks, a map with such publications, etc., moreover, such analytics can be visualized in the advertiser's personal account, for example, in the form of graphs, charts, tables etc.) on publications on social media and on the effectiveness of external or internal advertising campaign(s). It is worth noting that the availability of publications on social networks is monitored by storing the publication token (for example, on server 3) and by checking that this token is valid, wherein during the verification process (in particular, using server 3), a user's publication is searched, for example, by a set of hashtags, name (or user registration data) and the time of publication—if there is a match between the data stored in the token and the publication, then the publication is considered not being deleted (i.e. present on a social network). If the publication has been deleted, then the points accrued to the user for such publication are deleted; those points that were accrued by the same means. It is also worth noting that the mentioned automatic publication of content can be carried out through server 3, in particular using the API (for example, in the API a social network has methods for activating various functions, including posting content) of at least one of the social networks (social media). So, for example, when registering in the user's application, the user gives the server 3 permission to publish (so the permission to publish includes making a request to the social network API, for which a token (access key) is provided, which confirms that application 213 has the right to publish to the user's profile), to place the content (photos, videos, etc.), and also allows the transfer of the necessary attributes (in particular, a token (access key), allowing access of the application 213 to the user profile) for placement of the content by the server 3.

In the particular case of the implementation of the present technical solution, the server 3 may be a web server with software installed thereon, performing user application requests. So, for example, server 3 may be a cloud server, service and/or platform.

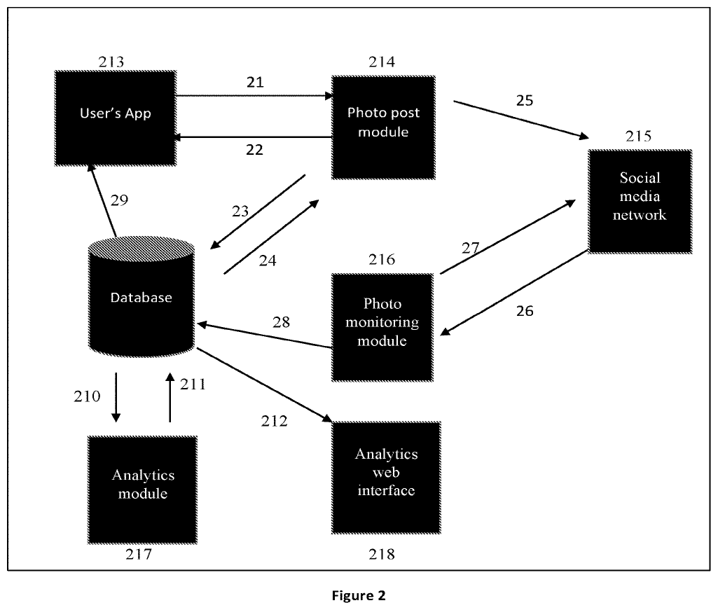

In one embodiment of the technical solution, element 4 of FIG. 1 is a database, in particular, an advertising database (a database of advertising/promotional materials), which is part of the computer system described in this technical solution for evaluating the effectiveness of outdoor or indoor advertising shown in FIG. 2. In one or more embodiments of the technical solution, the advertising database 4 stores information about user 1 (for example, nickname (user account), phone number, email address, gender, age) and manages any information about user 1. Also, the advertising database 4 stores the parameters of advertising campaigns (through which the parameters of advertising campaigns are controlled, which are described in more detail below), including, but not limited to, advertising tariffs and/or other prices (cost) related to the publication of advertising materials in various social media networks, restrictions on such publications (for example, only persons over 25 years old, or only girls or men, etc. can make publications), as well as other parameters of the advertising campaign. The mentioned information about user 1 may contain data such as gender, age, number of friends (subscribers), likes, user reposts, etc. Such information can be obtained by the described system, for example, by obtaining such data from the user or from open data from social networks.

In one embodiment of the technical solution, element 4 of FIG. 1 is a database, in particular, an advertising database (a database of advertising/promotional materials), which is part of the computer system described in this technical solution for evaluating the effectiveness of outdoor or indoor advertising shown in FIG. 2. In one or more embodiments of the technical solution, the advertising database 4 stores information about user 1 (for example, nickname (user account), phone number, email address, gender, age) and manages any information about user 1. Also, the advertising database 4 stores the parameters of advertising campaigns (through which the parameters of advertising campaigns are controlled, which are described in more detail below), including, but not limited to, advertising tariffs and/or other prices (cost) related to the publication of advertising materials in various social media networks, restrictions on such publications (for example, only persons over 25 years old, or only girls or men, etc. can make publications), as well as other parameters of the advertising campaign. The mentioned information about user 1 may contain data such as gender, age, number of friends (subscribers), likes, user reposts, etc. Such information can be obtained by the described system, for example, by obtaining such data from the user or from open data from social networks.

Also, at least one of the aforementioned databases can be hierarchical, object, object-oriented, object-relational, relational, centralized, fragmented/partitioned, replicated, spatial, etc., and for management, creation and database utilization, various database management systems can be used.

In one embodiment of the technical solution, element 5 of FIG. 1 is at least one social media server, which can be part of a third-party social network (third-party network), such as Facebook/Facebook, VKontakte/VKontakte, Instagram/Instagram, Twitter/Twitter and/or any other available now or in the future social media network. Elements of the claimed (and described) in this technical solution computer system for evaluating the effectiveness of outdoor or indoor advertising shown in FIG. 1, can be interconnected via a data network, for example, the Internet or any other suitable means of communication (communication/connection method).

It is worth noting that the modules (devices, etc.) described in the scope of this technical solution can be connected to each other by at least one type of communication (wired or wireless), including various types of bus structures (e.g., system bus, peripheral bus, local bus, memory bus, etc.), as well as various interfaces (serial port interface, parallel port, game port, universal serial bus (USB), network interface, and etc.) adapters (e.g. display adapter/video adapter, network adapter, the controller adapter, a USB adapter, etc.) and others.

Communication of the described modules and/or their constituent parts described in the scope of this technical solution can be carried out by means of wired and/or wireless means/methods of communication, as well as through various types of connections, including detachable or one-piece (for example, through terminals, contacts, adapters, soldering, mechanical connections, threads, etc.) wires, etc. So, for example, such means of communication can be implemented (can be used), for example, through local area networks (LAN), a USB interface, an RS-232 standard interface, Bluetooth, Wi-Fi interfaces, the Internet, and mobile cellular communications (GSM), in particular, in the bands 850-1900 MHz, satellite communications, trunking communications and data transmission channels with ultra-low power consumption, forming complex wireless networks with mesh topology (ZigBee) and other types of communication/connection. In the particular case of the implementation of this technical solution, data transfer between modules/devices/systems of this technical solution can be carried out using HTTP protocols (Hyper Text Transfer Protocol), HTTPS (HyperText Transfer Protocol Secure —extension of the HTTP protocol, to support encryption in order to increase security), FTP (File Transfer Protocol), TCP/IP, POP3 (Post Office Protocol), SMTP (Simple Mail Transfer Protocol), TELNET, DTN and etc., including through protocols, IEEE 802.15.4 and Z standards igBee, including APS (Application Support Sublayer) and NWK using services of the lower layers, the level of access control for the MAC environment and the physical layer PHY and others.

It is also worth noting that at least one user and/or at least one module of the described system, service, etc. can be notified (for example, of publication, repost, like, accrued points, etc.) through the described application and/or services, including through the use of messages from applications and services (systems) of instant messaging, chats, social networks, video and/or audio broadcasts, recordings, streams, etc., through the short message service, through API services, applications, modules, etc., including the described services, including short message service and exchange service instant messaging.

It is worth noting that at least one module of the described system or at least one part of such a module, service, and/or at least one part of such a service can be implemented by a text and/or graphical interface, for example, a web interface, an application, a part of an application (for example, an application window, an application layer, an application window area, a panel, a button, a graphic or text element of an application, a web interface, etc.).

FIG. 2 shows an exemplary embodiment of the internal data streams and commands between the various components (elements) of the claimed (and described) the present technical solution of the computer system for evaluating the effectiveness of the outdoor or indoor advertising shown in FIG. 1. In particular, in one or more embodiments of the technical solution, data 21 is transferred between the mobile application of the user 213 and the photo and video publishing module 214 (which receives data from the application 213, in particular, photos and video, text and etc., and publishes them to at least one social network by using the API of such a social network) when the user publishes a photo or video. In this case, the mobile application (user) 213 sends to the server 3 such data as a photo or video, user identifier (ID) (a unique user identifier in the application 213, which is assigned to the user by the application 213 and/or means of the server 3 during initial registration in described system and used to identify the user), the identifier (ID) of the advertising campaign (assigned when creating the advertising campaign on server 3 and used for identification), GPS location (where the photo or video was created given), as well as a list of social media networks with permissions (rights) for the implementation (creation, placement) of publications in them. It is worth noting that the above list of social (media) networks is created for each user based on the user profile (the user can connect the social networks in which he is registered in his user profile) and the settings of at least one advertising campaign. It is also worth noting that the mentioned publication permissions in such social (media) networks are specific tokens of social (media) networks in order for module 214 to enable the publication of content on behalf of the user. It is also worth noting that the settings of an advertising campaign may contain restrictions on publications on social networks (for example, on publications only on certain social networks, for example, only on one social network), so user publications will be carried out according to such restrictions, for example, to certain social networks.

In one or more embodiments of the technical solution, data transfer 22 (which are described in more detail below) is performed between the photo or video publishing module 214 and the user's mobile application 213, when server 3 (in response to the user's actions in application 213, in particular, the user's actions in sections of the application 213) sends the mentioned data, which contain a list of active advertising campaigns with prices applicable to the user, the current status of publications made by the user, and the total number of points earned by the user for each publication made. It should be noted that the formation of the list of active advertising campaigns is carried out by the server 3 administrator, and each advertising campaign with the parameters of such advertising campaigns is created by the server 3 administrator and then a list of advertising campaigns is automatically generated for each user using the advertising campaign parameters. It is also worth noting that the calculation of the total number of points earned by the user for publication is calculated on the basis of the tariff, the method (in particular, the formula) of which is presented below. So, for example, the number of friends (subscribers) of the user in a social network (media network) is multiplied by the corresponding coefficient, as described below, so for each user, server 3 calculates the cost of each user post and provides that value to the user in the user application.

In one or more implementations of the technical solution, the data transfer 23, which is further performed between the photo or video publishing module 214 and the database 4, includes combining the photo or video with the corresponding GPS position, user ID, as well as an advertising campaign ID.

In one or more embodiments of the technical solution, the data is transmitted 24, which is between the database 4 and the photo or video publishing module 214, and which is performed after the above mentioned data transfer 23, includes the transmission of data such as text and/or appropriate hashtags to attach to the publication for a particular campaign ID. It is worth noting that the mentioned text and/or corresponding hashtags can be created by the administrator of the server 3, in particular, in the settings of the advertising campaign. The mentioned text and hashtags are set (determined, set, etc.) in the parameters of the advertising campaign and then “attached” (automatically) to each publication (post) of the user, and, accordingly, such publications can be identified as described above, for example, in the process of establishing the fact that the publication has not been deleted. It is worth noting that in one advertising campaign the text and/or hashtags are the same for all users, and in this way a set of publications is created with one hashtag (necessary) for the advertiser.

In one or more embodiments of the technical solution, data transfer 25, which is further performed between the photo or video publishing module 214 and the social (media) network 215 (for example, the social network server 5 or server 3 via the corresponding APIs), includes the data transmission such as user-created photos or videos, permission (using a token) to publish (create posts) on behalf of the user, as well as text and/or hashtags for attaching to the mentioned publications/posts.

In one or more embodiments of the technical solution, the request 26 (which is, in a particular case, a binary response to the request 27—is there publications on the social network or not (for example, has been deleted)), subsequently sent by the social media network 215 to the module of tracking a photo or video 216, is a request: is there still a specific photo or video on the social media network. Moreover, the existence (presence) of photos or videos, which are a special case of a post (publication), is determined through the API using a unique publication identifier or, if the API does not have such a function (it is not possible to obtain such data through the API), then by hashtags (or a set of hashtags) and publication time. In one implementation of the present technical solution, the response to the request is a Boolean variable/logical variable (taking the value 1 if it exists, and 0 if it does not exist). The request 26 may also contain a request for the existing number of subscribers (from the English follower; synonyms: reader, follower, subscriber) of a user with a specific ID in each social network, the number of likes of a particular photo or video in each social media network, as well as the number of republishing (reposting) a particular photo or video in each social media network. It is worth noting that the determination of the number of likes of a particular photo or video in each social media network is carried out through the API of such a social (media) network, and the API contains functions whose methods allow you to get the number of likes.

In one or more embodiments of the technical solution, the data transmission 27, which is performed between the photo or video tracking module 216 (which makes a request to the social network, in particular, via the API, to establish the fact of the presence of a particular publication or the fact of its removal, and transmits the identifier of this publication in the process of the data transfer 27) and the social media network 21, which is the response to the request 26; the data transmission 27 includes the transmission of data such as photo or video ID and permissions necessary to obtain certain data (whether the publication exists or has been deleted) from the social (media) network.

In one or more embodiments of the technical solution, the data transfer 28, which is further performed between the photo or video tracking module 216 and database 4, for each photo or video ID returns the number of user subscribers for a particular user ID in each social networks, the number of likes of a particular photo or video in each social network, as well as the number of reposts of a certain photo or video in each social media network at the end of the tracking period, in particular, monitoring (or zero, if photo or video has been removed from the user's social networking sites during the tracking/monitoring period). It is worth noting that the mentioned tracking period can be set in the settings of the advertising campaign on server 3, and the mentioned monitoring period is a parameter that is responsible for sending at least one request 27 during the said period or, at least, after the said period.

In one or more embodiments of the technical solution, the data transfer 29, which is subsequently performed between the database 4 and the mobile application of the user 213, includes the transmission of data such as the number of points earned by the user for a particular photo or video (in the form of a total of points for photo or video in each social media network), all data about the corresponding advertising campaign (tariff per photo or video for each social media network, as well as a list of GPS positions of all objects participating in external or internal advertising campaigns, which can be static and dynamic (for example, the location of cars with stickers/stickers)).

In one or more embodiments of the technical solution, the data transmission 210, which is subsequently performed between the database 4 and the analysis module (analysis module, analytics module) 217 (in particular, module 217 compares the publication and the objects that were published by the user (which were “hunted” as part of the quest), moreover, this module provides statistics on how successful the advertising campaign was, in particular, in accumulated points to the user or to the advertiser, etc.), for each advertising campaign and photo or video inside (within) the campaign, includes the transfer of such data as (all) information stored in the database 4, which is associated with the photo or video (for example, GPS location/position, ID (unique identifier) of the user for the corresponding user who made the photo or video, the number of subscribers/likes or reposts for this photo or video, as well as the corresponding user ID in each social media network), and also information on the campaign (for example, tariffs for social media accounts, GPS position and a description of all physical objects (for example, billboards, etc.) participating in an outdoor or indoor advertising campaign).

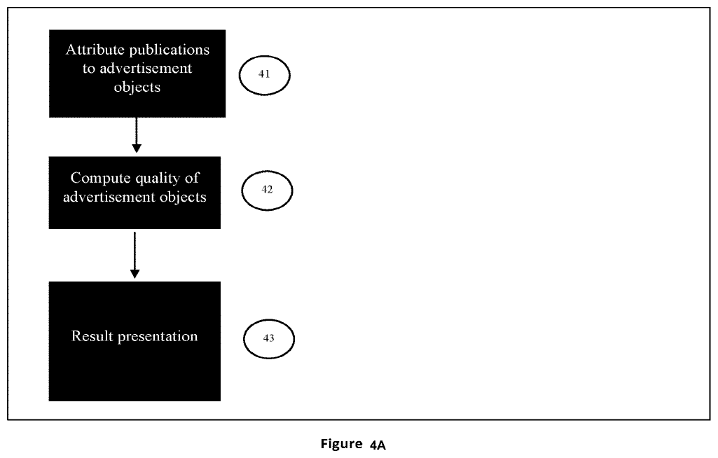

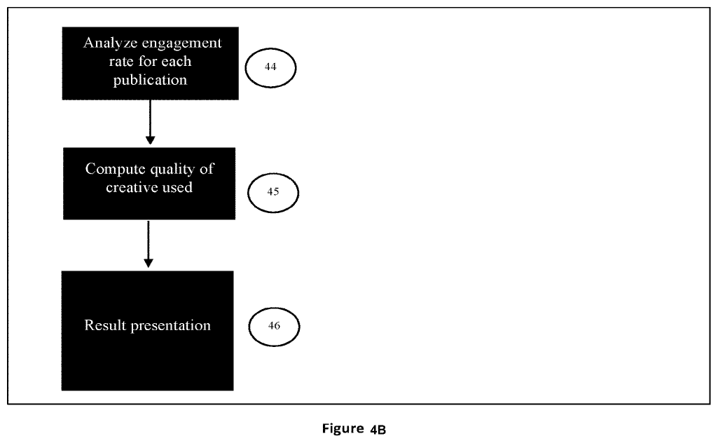

In one or more embodiments of the technical solution, the data transfer 211, which is subsequently performed between the analytical module 217 and the database 4, includes the transmission of data such as the number of points earned by the user for a particular published photo or video, as well as processed analytical data for the advertising campaign. It is worth noting that the processed analytical data for the advertising campaign includes established relationships, in particular, correspondences (step 41, FIG. 4A) between physical objects and photos, as well as statistical conclusions based on them, and the not yet processed data is a set of physical objects and photos that are stored in the database (in particular case, in the form of arrays of GPS coordinates and object IDs, publication IDs, etc.). It is worth noting that the above correspondence is carried out using one of the mathematical methods, in particular, through the use of Voronoi diagrams, as described in the scope of this technical solution, which allows, for example, to build (create) correspondence between two sets of points on the X and Y plane, where each point from the set Y (for example, publishing, in particular, a photo or video with corresponding coordinates about the location at which the mentioned photo or video was created, or a set of coordinates, per hour location, GPS coordinates) is mapped to a point from the set X (objects of an advertising campaign, photos or videos of which are published by users (objects of “hunting”, quest)).

In one or more embodiments of the technical solution, the data transmission 212, which is subsequently performed between the database 4 and the analytics web interface 218 (accessed by the advertiser and which allows visualizing (displaying) the statistics described in the present technical solution), includes any and all analytical data for display to the user in graphical and/or digital form, suitable for convenient viewing. Moreover, such data can include any data that can be established after making the above-mentioned correspondence, which, for example, can include the best and worst 10 percent of all billboards that were “hunted”, etc.

It is worth noting that the modules 214, 216, 217 and 218 are located on the server 3.

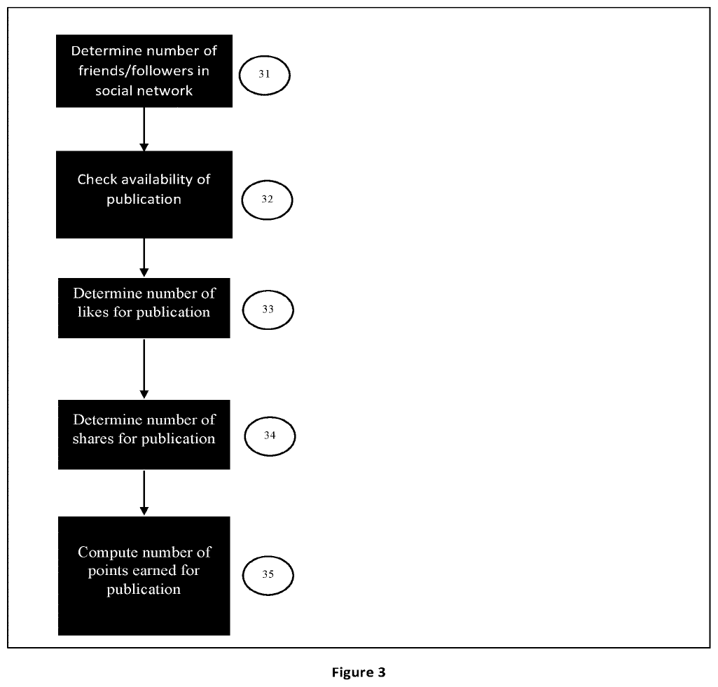

FIG. 3 shows an exemplary block diagram of an embodiment of a software algorithm for counting (calculating) user rewards in connection with outdoor or indoor advertising, performed in combination with the computer system shown in FIG. 1. In particular, the shown algorithm calculates the number of points earned (received) by the user for posting (publishing) specific content, in particular, photos and/or videos.

In one or more embodiments of the technical solution in the first step 31, the user publishes a photo or video in at least one social network using the provided functionality and means of the mobile application 213, for example, by selecting the application button “Publish.” Also, in this step, through the module 214, the server 3 (in particular, via the social media API) receives the number of friends and subscribers of the user from the user profile in the mentioned social network (referring to “F” later in the description of the technical solution, which in a particular case is the sum of friends and subscribers of the user in at least one social media network). It is worth noting that in the process of publishing content by the user, the user can select at least one social media network in which this publication will be made in the user's mobile application 213. After the user has expressed his intention to make a publication using the mobile application, this publication is placed on one of the social media networks through the publication module 214 using the described APIs.

In one or more embodiments of the technical solution in the next step 32, which is performed after a certain period of time, which can be adjusted in the settings, (by default, the specified period of time is 5 days), the specified algorithm checks: is the user's publication on the social network currently available? In particular, since the publication can be deleted, for example, by the user, the described algorithm checks (via module 216) whether the publication exists and whether it can be accessed without any restrictions by any user. It is worth noting that the mentioned restrictions (depending on the social network) include: the visibility of the publication only by friends, a group of people, the community, etc. In one implementation of this technical solution, if the publication's settings contain “only available to the user's friends”, then such a publication is considered by server 3 as “inaccessible”. Further, the described algorithm returns zero (i.e., the points for this publication of the user are reset) if the publication is not available. Otherwise, the algorithm proceeds to the next step 33.

In one or more embodiments of the technical solution, if in the previous step 32 the algorithm detected (determined) that the publication is (still) available, then in the next step 33 (by module 216), the algorithm proceeds to determine the number of “likes”, collected/received by publication on a social network (if such “likes” exist on a social network, otherwise their number is zero). Thus, the number of “likes” is determined, indicated by the letter “L” in order to calculate the number of points that are awarded to the user for publication, as described in the scope of the present invention and, in particular, below.

In one or more embodiments of the technical solution, if in the previous step 32 the algorithm determines that the publication is (still) available, in the next step 34 (by the module 216) the algorithm receives the number of reposts via the API of one of the social media networks, collected by the corresponding publication on the social network (if reposts are applicable to the social network (for example, exist on the social network), otherwise zero is returned). The number of reposts is indicated by the letter “S” for the purpose of calculation/calculations below.

In one or more embodiments of the technical solution in the next step 35 (performed by the database means), the specified algorithm reads the tariff card (in the particular case, which is the cost of publication, and the tariff card is calculated on the basis of the tariff for a specific publication) for an advertising campaign, corresponding to a certain publication and a certain social network from database 4, which may be the price (cost) for a friend/subscriber (pF), the price for like (pL) and the price for repost (pS), the limit for a friend/subscriber (limF), limit for like (limL) and limit for republish/repost (limS), which are set in the settings of the advertising campaign. Further, the algorithm returns the result of the calculations, in particular, the number of points P received/earned by the user for a specific publication on a specific social network, which are calculated in accordance with the following formula:

P=if(F>limF; LOG(F; 2)*pF*limF/LOG(limF; 2); pF*F)+if(L>limL; LOG(L; 2)*pL*limL/LOG(limL; 2); pL*L)+if(S>limS; LOG(S; 2)*pS*limS/LOG(limS; 2); pS*S)

Mathematically, this means that the algorithm switches from a linear payout function to a logarithmic function after a certain level specified in the settings of the (corresponding) advertising campaign.

FIG. 4A shows an exemplary embodiment of an algorithm for processing analytical data in order to calculate the effectiveness of advertising equipment (for example, billboards and other advertising structures) used in an outdoor and/or indoor campaign.

In step 41 (by module 217), the algorithm receives as an input a set of publications (stored in the database as an array) made for a specific advertising campaign (for each publication for which there is a GPS position associated with it, the number of likes, the number of reposts and the number of friends/subscribers on the social network collected by this publication, etc.) and a set of advertising objects (identifiers (which are text (name) or number), and GPS positions (GPS locations, GPS positions). In this step, processing is performed (in particular, using Voronoi diagrams) for each publication and assigning it to one of the advertising objects (so that each advertising object has a set of unique publications) using the Voronoi Diagram algorithm (https://en.wikipedia.org/wiki/Voronoi_diagram) with two sets of GPS positions (advertising objects as a finite set of points (“seeds”), and publications as a second set). Thus, the result of the Voronoi diagram algorithm is a unique set of publications associated with each advertising object, which is used for statistical calculations, described in the context of the present invention.

Next, in the step 42 (by module 217), for each advertising object, the number of publications (“N”) related thereto is calculated (from the step 41), in particular by means of the Voronoi diagram. Thus, for each advertising object, the number of publications (N) associated with such an advertising object is calculated, in particular, for constructing (creating) statistical conclusions about the effectiveness of the advertising campaign, for example, by the number of user publications associated with the particular billboard a statistical conclusion should be made about which billboard was detected (noticed) and whose photo was later published by the user and which billboard was not detected. To determine the statistical distribution (in particular, which are statistical conclusions) of advertising objects based on N and the total number of publications in a campaign, such as groups of the best or worst performing objects in a given campaign, the average efficiency of advertising objects in this campaign compared to the average indicators for other campaigns in the database, the comparison of the effectiveness of the same advertising object among (in relation to) several advertising campaigns and other analytics/analysis, standard computing tools are used.

Next, in step 43, the results are provided, in particular, through the web interface, the calculated statistical data (conclusions) are visualized (displayed).

FIG. 4B shows an exemplary version of the analytical data processing algorithm (obtained in the step 42) with the aim of calculating the effectiveness of creatives (in particular, placed on advertising objects, in particular billboards) used in an external and/or internal advertising campaign.

In the input step, the algorithm from the database receives a set of publications created by the user in the described application (which are stored on the server 3 and analyzed by the server 3, as described in the scope of this technical solution) for a specific advertising campaign (each publication may be associated with GPS position, number of likes, number of reposts and number of friends and/or subscribers on a social network (social media network) collected by this publication) and a set of advertising objects (names (object identifiers) with GPS locations). For each publication, the calculation of the levels of involvement (ER1, ER2, ER3) is carried out:

ER1=number of likes divided by the number of friends and subscribers;

ER2=number of republishings divided by the number of friends and subscribers;

ER3=number of views divided by the number of friends and/or subscribers; (This metric is only available if a video was used in an ad campaign).

If not all levels of engagement can be calculated on a particular social network, only those that can be calculated are used.

Next, in the step 45, the quality of the used creatives is calculated (in particular, publications, posts, content, etc.). In the step 41 described above, the attribution (relation, relationship) of each publication to the advertising object was determined and, therefore, the attribution to the media creative (content, media content) was determined, in particular the photo and video content used for this advertising object in a specific campaign. If there is only one type of creatives in the campaign, then all publications belong to one basket and can be compared with the creative used in other campaigns. If several creatives were used in the campaign, then we get publications related to each creative (basket) and then we can compare them with each other and with the creatives used in other advertising campaigns. It is worth noting that the carriers of content (creative), in particular, physical objects, are distributed in baskets in accordance with the creatives, in the particular case, how many creatives exist, so many baskets exist. Next, for each basket (in particular, containing homogeneous objects), metrics are calculated, which for each of the baskets can be compared with each other, in particular, to compare (evaluate) the quality of the creative.

For each creative, the calculation of the average ER1, ER2 and ER3 for publications in the corresponding basket, respectively, AER1, AER2 and AER3.

In step 46, standard computational tools are used to determine the statistical distribution of creatives based on AER1, AER2 and AER3, such as groups of the best or worst creatives in this campaign, average creative performance in this campaign, compared to average indicators for others campaigns in the database, comparing the effectiveness of creatives located on the same advertising object among several advertising campaigns (may be useful for determining social demography and audience profile for the particular advertising object) and other analytics (analysis), and carried out providing of such data to the user of the web interface, such as an advertiser.

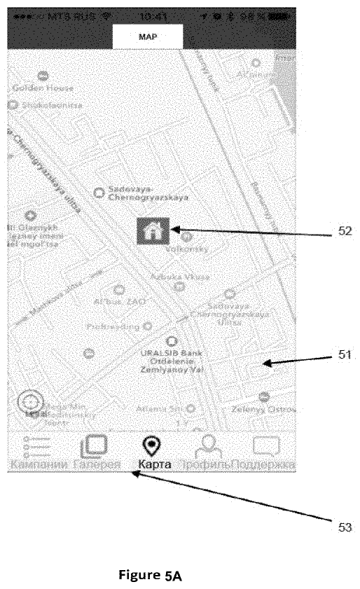

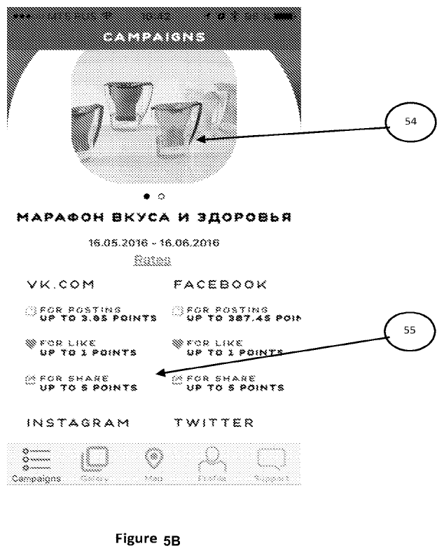

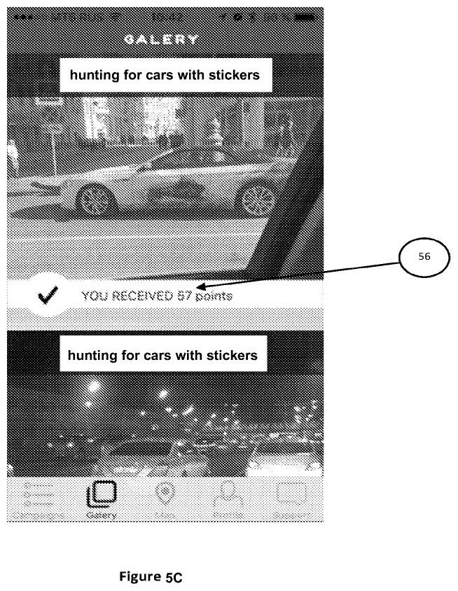

FIGS. 5A, 5B, and 5C show exemplary user interface variants of the aforementioned computer system for calculating the effectiveness of outdoor and indoor advertising depicted in FIG. 1.

In one or more implementations of the present technical solution, element 51 of FIG. 5A is a map showing details around a user's current location.

In one or more implementations of the present technical solution, element 52 of FIG. 5A is an advertising object on map 51 of one of the current advertising campaigns.

In one or more implementations of the present technical solution, element 53 of FIG. 5A is a navigation panel in which the user can switch between types of the Graphical User Interface (GUI): Campaigns, Gallery, Map, Profile and Support.

In one or more embodiments of the technical solution, element 54 of FIG. 5B is a scrollable list of available advertising campaigns.

In one or more implementations of the present technical solution, element 55 of FIG. 5B is the tariff for publishing to various accounts of social media networks (see step 35 above).

In one or more embodiments of the technical solution, element 56 of FIG. 5C is a gallery of publications made, and the number of points earned by the user for each publication (see step 35 described above).

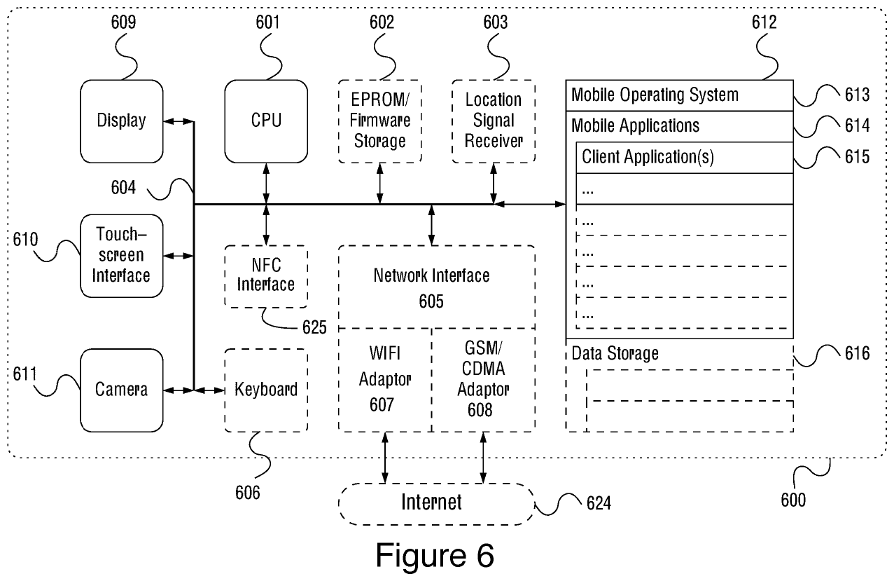

FIG. 6 illustrates an exemplary embodiment of a computer mobile system 600 that can be used as the mobile device of user 2 in combination with the system depicted in FIG. 1. In one or more embodiments, the mobile computer system 600 may be implemented in the form factor of a mobile computing device, such as a smartphone, personal digital assistant (PDA), tablet computer, or smartwatch, all of which are widely available for sale and well known to those skilled in the art.

The computer system 600 may include a data bus 604 or other connection or communication mechanism for transmitting information between and among various hardware components of the mobile computer system 600 and a central processing unit (CPU or simply a processor) 601 associated with the data bus 604, for processing information and performing other computational and management tasks (settlement and control tasks). Computer system 600 also includes memory 612, for example, random access memory (RAM) or other storage device associated with data bus 604, for storing various information, as well as instructions executed by processor 601. The memory 612 may also include permanent storage devices, for example, a magnetic disk, an optical disk, a solid state flash drive, or other non-volatile solid state storage devices.

In one or more implementations of the technical solution, the memory 612 can also be used to store temporary variables or other intermediate information during execution of instructions by the processor 601. Optionally, the computer system 600 may also include read only memory (ROM or EPROM) 602 or another static storage device connected to the data bus 604, for storing static information and instructions for the processor 601, for example, firmware is required for the operation of the computer system 600, the basic input/output system (BIOS), as well as various configuration parameters of the computer system 600.

In one or more implementations of the technical solution, the computer system 600 may include a display device 609, which may also be connected to the data bus 604 to display various information to the user of the computer system 600, such as the user interface screens shown in FIG. 4 and FIG. 5. In an alternative embodiment, the display device 609 may be coupled to the graphics controller and/or graphics processor (not shown). The display device 609 may be implemented as a liquid crystal display (LCD) made, for example, using thin film transistor technology (TFT) or organic light emitting diode (OLED) technology, both of which are well known to those skilled in the art. In various embodiments, the display device 609 may be combined in one common housing with the remaining components of the computer system 600. In an alternative embodiment, the display device 609 may be located outside such housing.

In one or more embodiments of the technical solution, the computer system 600 may also include a Near Field Communication (NFC) interface 625 coupled to the data bus 604 and configured to communicate with one or more NFC devices to determine its geographic location.

In one or more embodiments of the technical solution, the computer system 600 may include one or more input devices, such as the touch interface 610 for receiving tactile commands, the camera 611 for creating still images and videos of various objects, and the keyboard 606 that may be associated with the above data bus 604 for transmitting information, including, but not limited to, images and video, as well as the user instructions to the processor 601. An alternative embodiment of the technical solution for the input devices may include a system for tracking eye movements of the user (not shown) which may be used to indicate a user command selection for the computer system 600.

In one or more implementations of the technical solution, the computer system 600 may further include a location signal receiver 603 configured to scan the GPS signal or beacons, and transmit the scanned data described above to the processor 601 via the data bus 604.

In one or more implementations of the technical solution, the computer system 600 may further include a communication interface, for example, the network interface 605 connected to the data bus 604. The network interface 605 may be configured to establish a connection between the computer system 600 and the Internet 624 with using at least one WIFI interface 607 and the cellular adapter (GSM or CDMA) 608. The network interface 605 can be configured to allow two-way data transfer between the computer system 600 and the Internet 624. The WIFI interface 607 functions in conjunction with the 802.11a, 802.11b, 802.11g and/or 802.11n protocols, as well as the Bluetooth protocol, which are well known to those skilled in the art. In an exemplary embodiment of the technical solution, the WIFI interface 607 and the cellular network adapter (GSM or CDMA) 608 sends and receives electrical or electromagnetic signals carrying digital data streams representing various types of information.

In one or more embodiments of the technical solution, the Internet 624 typically provides data transmission through one or more subnets to other network resources. Thus, the computer system 600 is capable of accessing various network resources located anywhere in the Internet 624, for example, web servers, other content servers, as well as other resources of network storage devices. In one or more embodiments, the computer system 600 is configured to send and receive messages, multimedia data, and other data, including application program code, through various networks, including the Internet 624 via the network interface 605. For example, on the Internet, when the computer system 600 acts as a network client, it can request code or data for an application running on computer system 600. Similarly, it can send various data or computer code to other network resources.

In one or more embodiments of the technical solution, the computer system 600 uses a network interface 605 to send/transmit a request/requests via the Internet 624, for example, HTTP requests, to servers 3 and to receive various information, including, but not limited to, the above information displayed by the user using the user interface shown in FIG. 4 and FIG. 5.

In one or more embodiments of the technical solution, the functionality described here is implemented by the computer system 600 by the processor 601 that executes one or more sequences of one or more instructions contained in the memory 612. Such instructions can be read into the memory 612 from another computer readable media. The execution of the sequences of instructions contained in the memory 612, leads to the execution of various described process steps by the processor 601. In alternative embodiments of the technical solution, a wired circuit may be used, or in combination with the software instructions. Thus, the implementation options of this technical solution are not limited to any particular combination of hardware circuitry and software.

The term “computer-readable medium”, as used here, refers to any medium/tool that is involved in providing instructions to the processor 601 for their implementation. Computer-readable media is just one example of machine-readable media that may contain instructions for implementing any of the methods and/or technologies described herein. Such a storage medium may be of various types, including, but not limited to, non-volatile media and volatile media.

General types of non-volatile computer-readable media include, for example, a floppy disk, hard disk/hard disk drive, magnetic tape or any other magnetic medium, CD-ROM, any other optical medium, punch cards, paper tapes, any other physical media (data) with patterns of holes, RAM, PROM, EPROM, FLASHEPROM, flash drive, memory card, any other chip or memory cartridge, or any other medium from which the computer can read. Various types of computer-readable/machine-readable media may be involved in transferring one or more sequences of one or more instructions to the processor 601 to execute them. For example, instructions can initially be transferred to a magnetic disk from a remote computer. Alternatively, the remote computer can load instructions into dynamic memory and send instructions via the Internet 624. In particular, computer instructions can be loaded into the memory 612 of the computer system 600 from the above remote computer via the Internet 624 using a variety of network data transfer protocols, well known in the art.

In one or more embodiments of the technical solution, the memory 612 of the computer system 600 may store any of the following software, applications, or modules:

1. The operating system (OS) 613, which may be a mobile operating system for implementing basic system services/services and managing various hardware components of a computer system 600. Exemplary versions of an operating system 613 are well known to those skilled in the art and may include iOS, Android, Windows Mobile or any other mobile operating system systems currently known or developed in the future.

2. The mobile applications 614 may include, for example, a set of software applications executed by the processor 601 of the computer system 600 that allow the computer mobile system 600 to perform certain predetermined functions, for example, receiving GPS position data and transmitting them to the server 3, receive information for displaying to the user and for displaying this information to the user using a graphical user interface displayed on the display device, as described above in conjunction with FIG. 4 and FIG. 5. In one or more embodiments of the technical solution, the mobile applications 614 may include, for example, the client application 615.

3. The data storage 616 can be used, for example, to store information about the location/position of the client device, as well as other data, for example, points (points) earned by the user, distance traveled, duration of the trip, as well as other relevant statistical information.

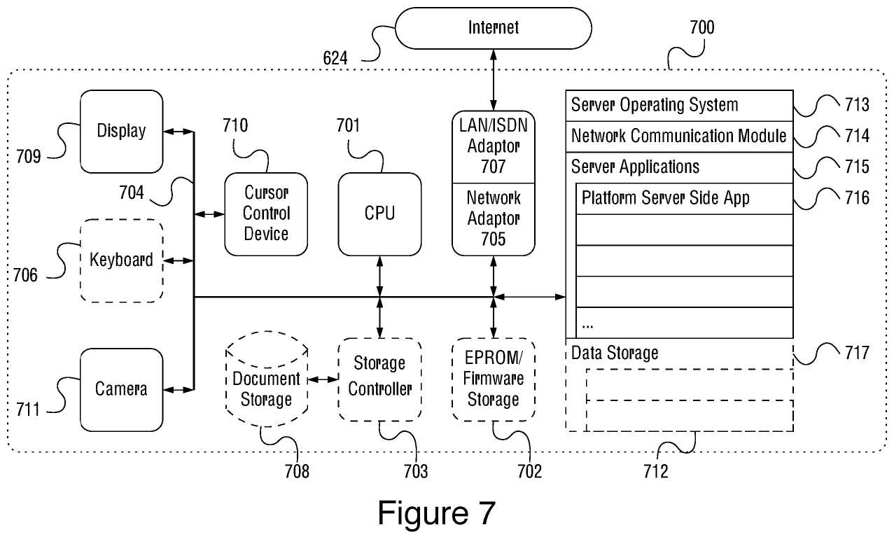

FIG. 7 illustrates an exemplary embodiment of the computer server system 700, which can be used, for example, as the server 3 of the inventive system, to evaluate the effectiveness of outdoor or indoor advertising shown in FIG. 1. It is worth noting that other components of the described system, such as a database processor/DBMS 4, can also be deployed/hosted on the computer server system 700.

In one or more embodiments of the technical solution, the computer server system 700 may include the data bus 704, which may be substantially similar and may perform similar functions as the data bus 604 of the computer system 600 shown in FIG. 6. In various embodiments of the technical solution, the data bus 704 may use the same or different connection and/or communication protocol as the data bus 604. One or more processors (CPUs) 701, network adapter 705, EPROM/Firmware 702 storage, display device 709 and the keyboard 706 of the computer system 700 may also be substantially similar to those of the processor 601, the network interface 605, the EPROM/Firmware 602 storage, the display device 609, and the keyboard 606 of the computer system 600, except that the first components are deployed in the configuration of the server platform. In various embodiments of the technical solution, one or more processors 701 may have significantly increased processing power compared to processor 601.

In addition to the input device 706 (keyboard), the computer server system 700 may further include a cursor control device 710, for example, a mouse, trackball/trackball, or direction keys with a cursor to transmit direction information and select/enter commands to the processor 701 and to control cursor movement on the display device 709. Such an input device typically has two degrees of freedom along two axes, a first axis (e.g., x) and a second axis (e.g., y), which allows the device to indicate a position on the plane.

The LAN/ISDN adapter 707 of the computer server system 700 may be implemented, for example, using a Service Integrated Digital Network Card (ISDN) or modem to provide a data connection with an appropriate type of telephone line connected to the Internet 624 using Internet service provider equipment (not shown). As another example, the LAN/ISDN adapter 707 may be a network interface card (LAN NIC) for providing a connection for exchanging data with compatible LANs and the Internet 624. To store various data files, the computer server system 700 may be provided with a data storage 708 for the purpose of storing various statistics displayed to the user by the storage controller 703. A camera 711 may be used to create images and/or video of various objects.

In one or more embodiments of the technical solution, the memory 712 of the computer server system 700 may store any of the following software, applications, modules, and/or data:

1. A server operating system (OS) 713, which may be an operating system for implementing basic system services and managing various hardware components of the computer server system 700. Exemplary server operating systems 713 are well known to those skilled in the art and may include Windows Server, Mac OS, Unix, AIX, FreeBSD, Linux, as well as any other operating systems currently known or developed in the future.

2. The network connection module 714 may include, for example, one or more stacks of network protocols that are used to establish a network connection between the computer server system 700 and various Internet 624 network entities, such as the computer mobile system 600, using the network adapter 705, operating in conjunction with the LAN/ISDN adapter 707.

3. The server applications 615 may include, for example, a set of software applications executed by one or more processors 701 of the computerized server system 700 that allow the computer server system 700 to perform certain predetermined functions or tasks. In one or more implementations of the technical solution, the server applications 715 may include the server-side application 716, the functionality of which has been described in more detail above. Additionally, the database management system 717 may be provided for storing and controlling access to various information, as described in more detail above.

4. The data warehouse 719 can be used, for example, to store user data, geographical location/position data, tariff data, user scores (points), as well as any other data described above that may be stored as one or more database tables containing database records.

In conclusion, it should be understood that the processes and technologies described herein are not inherently related to any particular device and can be implemented by any suitable combination of components. In addition, various types of general-purpose devices can be used in accordance with what is described here. It may also be appropriate to create a specialized device for performing the steps of the method described here. This technical solution is described with reference to specific examples, which are in all respects intended to illustrate and not limit. Those skilled in the art will understand that many different combinations of hardware, software, and firmware are suitable for implementing the present technical solution. For example, the described software can be implemented in a wide range of programming languages or scripting languages such as Assembler, C/C++, Objective-C, perl, shell, PHP, Java, as well as in any programming language currently known or developed later or scripting language.

Furthermore, other implementations of the present technical solution will be apparent to those skilled in the art upon consideration of the present description and application of the technical solution disclosed herein. Various aspects and/or components of the described options can be used individually or in any combination in systems and methods for evaluating the effectiveness of outdoor or indoor advertising(s). It is assumed that the description and examples will be considered only as examples, while the true scope and essence of the technical solution are indicated in the following technical solution formula.

What is claimed is:

1. A computer-implemented method for calculating a user promotion in conjunction with outdoor or indoor advertising, the method being performed in conjunction with a computer system comprising a central processor, a positioning device, a display device, and a memory, the computer-implemented method comprising:
a) the use of a central processor for publishing photos or videos created by the user on a social network;
b) checking whether photos or videos published on the social network are still available;
c) if the published photos or videos are still available, the level of interaction of other users with the published photos or videos is determined;
d) determination of information about the tariff applicable to the advertising campaign corresponding to the published photo or video and social network; and
e) calculation of the number of points (P) received by the user for published photos or videos on the social network based on certain tariff information and a certain level of interaction.

2. The method implemented on a computer according to claim 1, characterized in that the level of interaction of other users with the published photos or videos is determined based on the number (L) of “likes” collected by the published photos or videos on the social network.

3. The computer-implemented method according to claim 1, characterized in that the level of interaction of other users with the published photos or videos is determined based on the number of reposts (S) collected by the published photos or videos on the social network.

4. The computer-implemented method according to claim 1, characterized in that the level of interaction of other users with the published photos or videos is determined based on the number of views (V) of the published photos or videos on the social network.

5. The method implemented on a computer according to claim 1, characterized in that the tariff information includes the price for a friend/subscriber (pF), the price for “like” (pL) and the price for repost (pS), the limit for a friend/subscriber (limF), the limit for likes (limL) and the limit for reposts (limS), the price per watched video (pV) and the limit for the number of times a video can be watched (limV).

6. The computer-implemented method according to claim 1, which further includes determining the number (F) of friends and subscribers of the user profile on the social network and in which the number of points (P) received by the user for the published photos on the social network, is calculated in accordance with the formula:
P=if(F>lim F;LOG(F;2)*pF*lim F/LOG(lim F;2);pF*F)+if(L>lim L;LOG(L;2)*pL*lim L/LOG(lim L;2);pL*L)+if(S>lim S;LOG(S;2)*pS*lim S/LOG(lim S;2);pS*S)
or any other function that is linear in the number of friends, the number of likes, the number of reposts and switches to the logarithmic after a certain limit, and in which the formula for the published video is:
P=if(V>lim V;LOG(V;2)*pV*lim V/LOG(lim V;2);pV*V)+if(L>lim L;LOG(L;2)*pL*lim L/LOG(lim L;2);pL*L)+if(S>lim S;LOG(S;2)*pS*lim S/LOG(lim S;2);pS*S)
or any other function that is linear to the number of times that the video has been viewed, the number of likes, the number of reposts and switches to the logarithmic after a certain limit.

7. A computer-implemented method according to claim 1, characterized in that checking whether photos or videos published on the social network are still available for a predetermined period of time includes determining whether published photos or videos exist and whether they can be accessed by any user without any restrictions.

8. The method implemented on a computer according to claim 7, characterized in that if the published photos or videos are not accessible to everyone, then they are considered as “inaccessible”.
